(19) United States
(12) Patent Application Publication
(10) Pub. No.: US 2018/0010009 A1
(43) Pub. Date: Jan. 11, 2018

(54) POLYMERS, COATING COMPOSITIONS, COATED ARTICLES, AND METHODS RELATED THERETO

(71) Applicant: VALSPAR SOURCING, INC., Minneapolis, MN (US)

(72) Inventors: Sebastien GIBANEL, Givry (FR); Benoit PROUVOST, Nantes (FR)

(21) Appl. No.: 15/545,071

(22) PCT Filed: Jan. 19, 2016
(86) PCT No.: PCT/US2016/013901

§ 371 Date: Jul. 20, 2017

Related U.S. Application Data
(60) Provisional application No. 62/105,501, filed on Jan. 20, 2015.

(51) Int. Cl. C09D 133/14; C09D 125/14; C08F 220/12; C08F 212/08; B65D 25/14; C09D 133/08; C08F 220/68; B05D 3/02

(52) U.S. Cl. CPC C09D 133/14; C09D 133/08; C09D 125/14; C08F 220/68; C08F 220/12; C08F 212/08; B65D 25/14; B05D 3/0272

(57) ABSTRACT

A coated article is disclosed that includes a metal substrate and a coating composition disposed on at least a portion of the metal substrate. The coating can be formed from a composition that includes an acrylic copolymer, which is preferably the reaction product of ethylenically unsaturated monomers and a functional monomer. The functional monomer can be the reaction product of a multifunctional isocyanate and an ethylenically unsaturated nucleophilic monomer. The functional monomer preferably includes a blocked isocyanate group. The articles can be useful for packaging foods and beverages.

### CROSS-REFERENCE TO RELATED APPLICATION(S)

This application claims the benefit of U.S. provisional application No. 62/105,501 filed 20 Jan. 2015 and entitled “Polymers, Coating Compositions, Coated Articles, And Methods Related Thereto”, which is incorporated herein by reference in its entirety.

### FIELD

This disclosure relates to articles, coating compositions, polymers, and methods that can be useful, for example, for coating the surfaces of a variety of articles, including packaging articles.

### BACKGROUND

A wide variety of coating compositions have been used to coat the surfaces of packaging articles (e.g., food and beverage containers). For example, metal containers can sometimes be coated using “coil coating” operations, i.e., a planar sheet of a suitable substrate (e.g., steel or aluminum metal) is coated with a suitable composition and cured. The coated substrate then can be formed into the can end or body. Alternatively, liquid coating compositions may be applied (e.g., by spraying, dipping, rolling, etc.) to the substrate and then cured.

Packaging coating compositions typically can be capable of high-speed application to the substrate and can provide, when cured, the necessary properties to perform in this demanding end use. For example, the resultant coating should be safe for food contact, have excellent adhesion to the substrate, and should resist degradation over long periods of time, even when exposed to harsh environments.

Many current packaging coating compositions contain mobile or bound 4,4′-(propane-2,2-diyl)diphenol (known as “bisphenol A” or “BPA”) or PVC compounds. Although the balance of scientific evidence available to date indicates that the small trace amounts of these compounds that might be released from existing coating compositions do not pose any health risks to humans, these compounds are nevertheless perceived by some people as being potentially harmful to human health. What is needed in the art is a packaging container (e.g., a food or beverage container) that is coated with a composition that does not contain extractable quantities of such compounds. Such packages, compositions and methods for preparing the same are disclosed and claimed herein.

### SUMMARY

In one aspect, an acrylic copolymer is provided that can be used in coating compositions, including organic-solvent-based or waterborne liquid coating compositions. In some embodiments, the acrylic copolymer is a water-dispersible polymer. In some such water-dispersible embodiments, the acrylic copolymer is an emulsion polymerized latex copolymer, an organic-solution polymerized acrylic copolymer, or a combination thereof. The acrylic copolymer may have utility in a wide variety of coating end uses, including coating compositions for use on the exterior or interior surfaces of packaging articles such as, for example, food or beverage containers. The acrylic copolymer preferably includes one or more pendant groups having one or more blocked isocyanate groups, which are preferably deblockable under coating cure conditions such that an isocyanate group is available for reaction with an isocyanate-reactive group. In some embodiments, the one or more isocyanate groups are present in a structural unit that is derived from a functional monomer which is the reaction product of a multifunctional isocyanate and an ethylenically unsaturated nucleophilic monomer. Typically, the pendant group is attached to a backbone of the acrylic polymer via a step-growth linkage, with ester linkages being preferred. In some embodiments, the pendant group is of the below formula:

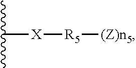

where:
X is an organic group that includes at least one heteroatom-containing linkage in a chain connecting R₅ to a backbone of the random copolymer, more typically X includes at least two heteroatom-containing linkages;
R₅ is an organic group, more typically an alkyl or cycloalkyl group that can, optionally, include one or more heteroatoms (e.g., O, N, P, S, etc.);
n₅ can have integral values of 1 to 4, more typically 1 or 2, and even more typically 1;
Z is, independently, an isocyanate or blocked isocyanate group, more typically Z is an isocyanate group.

In another aspect, an article (e.g., an article for packaging) is provided that includes a metal substrate and a coating composition disposed on at least a portion of the metal substrate. The coating can be formed from a coating composition that includes an acrylic copolymer having a pendant isocyanate group. The acrylic copolymer can be the reaction product of an ethylenically unsaturated monomer and a functional monomer. The functional monomer can be derived from the reaction product of a multifunctional isocyanate and an ethylenically unsaturated nucleophilic monomer. The functional monomer can include a blocked isocyanate group. In some embodiments, the article is at least a portion of a food or beverage container. In some embodiments, the ethylenically unsaturated monomers include an ethylenically unsaturated ester monomer and an ethylenically unsaturated carboxylic acid monomer. In some embodiments, the coating composition includes a crosslinker and the acrylic copolymer may be water-dispersible.

In another aspect, a method is disclosed that includes providing a coating composition comprising an acrylic copolymer having one or more pendant deblockable isocyanate groups attached to the acrylic copolymer and applying the coating composition to at least a portion of a metal substrate. The coating composition can include an acrylic copolymer which is the reaction product of an ethylenically unsaturated monomer and a functional monomer. The method further can include curing the coating composition to form an adherent hardened coating. In some embodiments, curing can be accomplished by heating the coating composition to a temperature of from about 150° C. to about 260° C. for from about 20 minutes to about 5 seconds.

In yet another aspect, an article for packaging is provided that includes a metal substrate and a coating disposed on at least a portion of the metal substrate. The coating can be formed from a coating composition that comprises a random copolymer having the following structural elements, each structural element bonded to another structural element in a random manner:

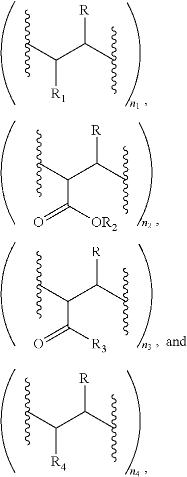

wherein each R is, independently, H or an alkyl group having one to four carbon atoms, wherein n₁ to n₄ are the number of structural elements of each type in the random copolymer, n₁ is an integer that is zero or greater, and n₂, n₃, and n₄ are, independently, integers of 1 or greater. In some preferred embodiments, n₁ is less than about 500 and n₂, n₃, and n₄ are, independently, less than about 50. R₁ is H or is a group derived from the copolymerization of one or more vinyl monomers, R₂ is an alkyl group having two to eight carbon atoms, R₃ is H or a salt-forming group, and R₄ is a group having the structure:

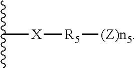

X is an organic group that includes at least one heteroatom-containing linkage in a chain connecting R₅ to a backbone of the copolymer (which may be a random copolymer in some embodiments). More typically, X includes at least two heteroatom-containing linkages. R₅ is typically an organic group, more typically an alkyl or cycloalkyl group that can, optionally, include one or more heteroatoms (e.g., O, N, P, S, etc.). n₅ can have the values of 1 to 4, more typically 1 or 2, and even more typically 1. Z is, independently, an isocyanate or blocked isocyanate group. More typically Z is an isocyanate group. In preferred embodiments, X has the following structure:

—(Y)n₆-R₆—W—

wherein n₆ is 0 or 1, more typically 1; Y, if present (i.e., if n₆ is 1), is a heteroatom-containing linkage, and more typically an ester linkage; R₆ is an organic group, more typically an alkyl or cycloalkyl group that can, optionally, include one or more heteroatoms (e.g., O, N, P, S, etc.); and W is a heteroatom-containing linkage, more typically a heteroatom-containing linkage formed by reacting an isocyanate group with an isocyanate-reactive group (e.g., hydroxyl, amino, or thio group), even more typically a urethane linkage.

In another aspect, an aqueous coating composition is provided that preferably includes at least 20 weight percent (wt %), based upon total nonvolatile weight, of an acrylic copolymer. Additionally, the aqueous coating preferably includes from about 2 wt % to about 30 wt % of a crosslinker that can be selected from isophorone diisocyanate, hexamethylene diisocyanate, and a mixture thereof. The coating composition can also include an aqueous liquid carrier. The coating composition can be substantially free of bisphenol A, 1,1-bis(4-hydroxyphenyl)methane (“Bisphenol F”), and 4,4′-sulfonyldiphenol (“Bisphenol S”) and can be suitable for use in forming a food-contact coating on a food or beverage container.

In another aspect, an acrylic copolymer is provided that can be used in coating compositions, including organic-solvent-based or waterborne liquid coating compositions. In some embodiments, the acrylic copolymer can be a water-dispersible polymer. In some such water-dispersible embodiments, the acrylic copolymer can be an emulsion polymerized latex copolymer, an organic-solution polymerized acrylic copolymer, or a combination thereof. The acrylic copolymer may have utility in a wide variety of coating end uses, including coating compositions for use on the exterior or interior surfaces of packaging articles such as, for example, food or beverage containers (e.g., food or beverage cans or portions thereof). The acrylic copolymer preferably includes one or more pendant groups having one or more blocked isocyanate groups, which are preferably deblockable under coating cure conditions such that an isocyanate group is available for reaction with an isocyanate-reactive group. Typically, the pendant group can be attached to a backbone of the acrylic polymer via a step-growth linkage, with ester linkages being preferred. In some embodiments, the one or more isocyanate groups can be present in a structural unit that is derived from a functional monomer which is the reaction product of a multifunctional isocyanate and an ethylenically unsaturated nucleophilic monomer.

In this disclosure, unless otherwise specified:

“substantially free” of a particular mobile or bound compound refers to disclosed compositions that contain less than about 1000 parts per million (ppm) of the recited mobile or bound compound;

“essentially free” of a particular mobile or bound compound refers to disclosed compositions that contain less than about 100 parts per million (ppm) of the recited mobile or bound compound;

“essentially completely free” of a particular mobile or bound compound refers to disclosed compositions that contain less than about 5 parts per million (ppm) of the recited mobile or bound compound; and

“completely free” of a particular mobile or bound compound refers to disclosed compositions that contain less than about 20 parts per billion (ppb) of the recited mobile or bound compound.

If the aforementioned phrases are used without the term “mobile” or “bound” (e.g., “substantially free of BPA”), then the recited material or composition contains less than the aforementioned amount of the compound whether the compound is mobile or bound. Thus, a coating composition that is “substantially free” of BPA contains less than 1,000 ppm, if any, of BPA, whether in mobile or bound form.

“Mobile” refers to a compound that can be extracted from a cured coating when the coating (typically approximately 1 mg/cm² thick) is exposed to a test medium for some defined set of conditions, depending on the end use. An example of these testing conditions is exposure of the cured coating to HPLC-grade acetonitrile for 24 hours at 25° C.;

“aliphatic group” refers to a saturated or unsaturated linear or branched hydrocarbon group such as, for example, alkyl, alkenyl, and alkynyl groups;

“alkyl group” refers to a saturated linear or branched hydrocarbon group including, for example, methyl, ethyl, isopropyl, t-butyl, heptyl, dodecyl, octadecyl, amyl, 2-ethylhexyl, and the like;

“cyclic group” refers to a closed ring hydrocarbon group that is classified as an alicyclic group, aromatic group, or heterocyclic group; and

“alicyclic group” refers to a closed ring hydrocarbon group that can include heteroatoms; and

“heterocyclic group” refers to a closed ring hydrocarbon in which one or more of the atoms in the ring is an element other than carbon (e.g., nitrogen, oxygen, sulfur, etc.). Substitution is anticipated on the organic groups of the polymers used in the coating compositions of the present disclosure.

As a means of simplifying the discussion and recitation of certain terminology used throughout this application, the terms “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like.

As used herein:

“vinyl addition polymer” or “vinyl addition copolymer” is meant to include acrylate, methacrylate, and vinyl polymers and copolymers. Unless otherwise indicated, a reference to a “polymer” is also meant to include a copolymer.

“(meth)acrylate” (where “meth” is bracketed) refers to acrylate, methacrylate compounds or mixtures thereof;

“dispersible” in the context of a dispersible polymer means that the polymer can be mixed into a carrier to form a macroscopically uniform mixture without the use of high shear mixing. The term “dispersible” is intended to include the term “soluble;”

“water-dispersible” in the context of a water-dispersible polymer refers to polymer that can be mixed into water to form a macroscopically uniform mixture without the use of high shear mixing and is intended to include the term “water-soluble;”

“dispersion” in the context of a dispersible polymer refers to the mixture of a dispersible polymer and a carrier. The term “dispersion” is intended to include the term “solution.”

Furthermore, the term:

“on” or “upon” used in the context of a coating applied to a surface or substrate refers to coatings applied directly or indirectly to the surface or substrate; and

“crosslinker” refers to a molecule, oligomer, or polymer that is capable of forming covalent linkages between two or more polymers or between two or more different regions of the same polymer.

As used herein, “a,” “an,” “the,” “at least one,” and “one or more” are used interchangeably. Thus, for example, a coating composition that comprises “an” acrylic copolymer can be interpreted to mean that the coating composition includes “one or more” acrylic copolymers.

The term “acrylic copolymer” as used herein is intended to be construed broadly and unless specifically indicated does not require that the polymer include any structural units derived from acrylic acid, methacrylic acid, or any other related acid-functional “acrylic” monomers. Thus, for example, the term “acrylic copolymer” shall also include acrylate copolymers made from monomer mixtures that include acrylate monomer(s) but do not include any such acid-functional acrylic monomers.

The provided articles, coatings, and methods are capable of high-speed application to at least a portion of metal substrates that can be part of, for example, food and beverage containers. The resulting cured coatings can produce articles that are safe for food contact, have excellent adhesion to the substrate, and resist degradation over long periods of time, even when exposed to harsh environments. The provided coatings and articles can be essentially free of mobile or bound bisphenol A, aromatic glycidyl ether compounds or PVC compounds. They also can be substantially free of formaldehyde.

The details of one or more embodiments are set forth in the accompanying description below. Other features, objects, and advantages will be apparent from the description and from the claims.

### DETAILED DESCRIPTION

In the following description it is to be understood that other embodiments are contemplated and may be made without departing from the scope or spirit of the present invention. The following detailed description, therefore, is not to be taken in a limiting sense. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The application of coating compositions to metals to retard or inhibit corrosion is well established. This is particularly true in the area of metal food and beverage containers. Coating compositions are typically applied to the interior of such containers to prevent the contents from contacting the metal of the container. Contact between the metal and the packaged product can lead to corrosion of the metal container, which can contaminate the packaged product. This is particularly true when the contents of the container are chemically aggressive in nature. Protective coating compositions are also applied to the interior of food and beverage containers to prevent corrosion in the headspace of the container between the fill line of the food product and the container lid, which is particularly problematic with high-salt-content food products.

Packaging coating compositions can be capable of high-speed application to a substrate and can provide the necessary balance of properties when hardened (cured) to perform in this demanding end use. For example, the coating composition can be safe for food-contact, not adversely affect the taste of the packaged food or beverage product, have excellent adhesion to the substrate, exhibit suitable flexibility, resist staining and other coating defects such as “popping,” “blushing” and/or “blistering,” and resist degradation over long periods of time, even when exposed to harsh environments. In addition, a coating composition for a food or beverage container should generally be capable of maintaining suitable film integrity during container fabrication and be capable of withstanding the processing conditions that the container may be subjected to during product packaging. Given the above challenges it is generally understood in the packaging art that compositions used in other applications (such as, for example, automobile coatings) are more often than not incapable of fulfilling the balance of stringent coating properties required for food-contact packaging coatings. Moreover, no reliable method exists to predict whether a particular class of coating compositions will pass all of these stringent requirements.

As a result of numerous experiments and field trials, various coating compositions have found use as interior protective coatings for food or beverage containers. Such coating compositions include epoxy-based coatings and polyvinyl-chloride-based coatings. Each of these coating compositions, however, has shortcomings. For example, the recycling of materials containing polyvinyl chloride or related halide-containing vinyl polymers may be problematic. There is also a desire by some to reduce or eliminate certain epoxy compounds used to formulate food-contact epoxy coatings.

To address the aforementioned shortcomings, the packaging coatings industry has sought coating compositions based on alternative binder systems such as polyester resin systems. It has been problematic, however, to formulate polyester-based coating compositions that exhibit the required balance of coating characteristics (e.g., flexibility, adhesion, corrosion resistance, stability, resistance to crazing, etc.). Thus, there is a continuing need for improved coating compositions.

Novel articles for packaging are provided that include a metal substrate and a coating composition disposed upon at least a portion of the metal substrate. The coating compositions can be formed from an acrylic copolymer made from the reaction of reactants including an ethylenically unsaturated monomer and a functional monomer.

The functional monomer can be derived from the reaction product of a multifunctional isocyanate and an ethylenically unsaturated monomer having one or more complimentary reactive functional groups such as, for example, an ethylenically unsaturated nucleophilic monomer. Nucleophilic acrylic ester are preferred ethylenically unsaturated nucleophilic monomers, and particularly nucleophilic (meth)acrylate ester monomers. The functional monomer includes one or more isocyanate groups, and more preferably includes a blocked isocyanate group.

The ethylenically unsaturated monomer, which is preferably included in the reaction mixture in addition to the functional monomer and can be a mixture of different monomers, can include a vinyl monomer that can help to modify the properties of the coating composition. In some embodiments, the vinyl monomer can help to increase the adhesion of the coating composition to the substrate. It can also modify the glass transition temperature of the resulting polymer. The ethylenically unsaturated monomer can also include an ester group. The ethylenically unsaturated monomer can include a carboxylic acid group. Exemplary ethylenically unsaturated monomers of this type can include methacrylic acid and acrylic acid.

In some embodiments, the acrylic copolymer can be the reaction product of a vinyl monomer, an ethylenically unsaturated ester-containing monomer, an ethylenically unsaturated acid functional monomer, and the functional monomer. In some embodiments, the acrylic copolymer can be the reaction product of an ethylenically unsaturated ester-containing monomer, an ethylenically unsaturated acid functional monomer, and the functional monomer.

The disclosed acrylic copolymers can be the reaction product of at least one acrylic monomer. In the present disclosure, acrylic monomer refers to any monomer derived from an ethylenically unsaturated carboxylic acid. Typically, this includes acrylic acid, methacrylic acid, or co-mixtures thereof, and their derivatives (e.g., anhydrides, esters, and amides). Acrylic copolymers are typically utilized due to their ease of manufacture, cost, abrasion resistance, toughness, durability, T_{g} characteristics, compatibility, ease of solubilizing or dispersing, and the like.

Provided acrylic copolymers can include the reaction product of an ester of an ethylenically unsaturated carboxylic acid, an ethylenically unsaturated carboxylic acid or anhydride, optionally a vinyl monomer, and a functional monomer, which is preferably derived from the reaction product of a multifunctional isocyanate and an ethylenically unsaturated nucleophilic monomer. In preferred embodiments, the functional monomer includes a blocked isocyanate group.

In some embodiments, the ethylenically unsaturated monomer includes an ester of (meth)acrylic acid. The ethylenically unsaturated monomer can also include a (meth)acrylic acid. Optionally, the ethylenically unsaturated monomer can include a vinyl monomer. In certain preferred embodiments, the ethylenically unsaturated monomer comprises a mixture of a (meth)acrylic acid, an ester of (meth)acrylic acid, and one optionally a vinyl monomer.

In some embodiments, provided acrylic copolymers can include the reaction product of monomers, oligomers, or polymer reactants. Typically, oligomer and polymer reactants for use in making the provided acrylic copolymer systems are low to medium molecular weight reactive species derived from the same or similar monomers used to make the acrylic copolymers.

As previously discussed, in some embodiments the reactants used to make the acrylic copolymer include an ethylenically unsaturated monomer, which can be a vinyl monomer. Vinyl monomers are well known to those skilled in the art of acrylic polymerization. Suitable vinyl monomers include styrene, methyl styrene, halostyrene, isoprene, diallylphthalate, divinylbenzene, conjugated butadiene, α-methylstyrene, vinyl toluene, vinyl naphthalene, benzyl (meth)acrylate, cyclohexyl methacrylate, and mixtures thereof. Other suitable polymerizable vinyl monomers include acrylonitrile, acrylamide, methacrylamide, methacrylonitrile, vinyl acetate, vinyl propionate, vinyl butyrate, vinyl stearate, and isobutoxymethyl acrylamide. In some embodiments, the acrylic copolymer may be made without using one or both of styrene or (meth)acrylamide-type monomers.

Suitable esters of ethylenically unsaturated carboxylic acids, such as (meth)acrylic acid (“alkyl (meth)acrylates”), include those having the structure: CH₂═C(R)—CO—OR₂ wherein each R can independently be hydrogen or methyl, and R₂ can be an alkyl group containing from one to sixteen carbon atoms. The R₂ group can be substituted with one or more, typically, from one to three moieties such as hydroxy, halo, phenyl, and alkoxy. Suitable alkyl (meth)acrylates therefore encompass hydroxyalkyl (meth)acrylates. The alkyl (meth)acrylate typically is an ester of (meth)acrylic acid. In some embodiments, R can be hydrogen or methyl and R₂ can be an alkyl group having from two to eight carbon atoms. Examples of suitable alkyl (meth)acrylates include, but are not limited to, methyl (meth)acrylate, ethyl (meth)acrylate, propyl (meth)acrylate, isopropyl (meth)acrylate, butyl (meth)acrylate, isobutyl (meth)acrylate, pentyl (meth)acrylate, isoamyl (meth)acrylate, hexyl (meth)acrylate, 2-ethylhexyl (meth)acrylate, cyclohexyl (meth)acrylate, decyl (meth)acrylate, isodecyl (meth)acrylate, benzyl (meth)acrylate, lauryl (meth)acrylate, isobornyl (meth)acrylate, octyl (meth)acrylate, isooctyl (meth)acrylate), nonylphenol ethoxylate (meth)acrylate, 1-hydroxyethyl (meth)acrylate, 2-hydroxyethyl (meth)acrylate, nonyl (meth)acrylate, isononyl (meth)acrylate, diethylene glycol (meth)acrylate, 2-(2-ethoxyethoxy)ethyl (meth)acrylate, butanediol mono(meth)acrylate, β-carboxyethyl (meth)acrylate, dodecyl (meth)acrylate, stearyl (meth)acrylate, hydroxyl-functional polycaprolactone ester (meth)acrylate, hydroxymethyl (meth)acrylate, hydroxypropyl (meth)acrylate, hydroxyisopropyl (meth)acrylate, hydroxybutyl (meth)acrylate, hydroxyisobutyl (meth)acrylate, tetrahydrofurfuryl (meth)acrylate, ethylene urea ethyl (meth)acrylate, 2-sulfoethylene (meth)acrylate, combinations of these and the like.

As previously discussed, in certain preferred embodiments, the acrylic copolymer also includes the reaction product of an ethylenically unsaturated carboxylic acid. A variety of acid-functional and anhydride-functional monomers can be used; their selection is dependent on the desired final polymer properties. Suitable ethylenically unsaturated acid-functional monomers and anhydride-functional monomers include monomers having a reactive carbon-carbon double bond and an acidic or anhydride group. Typical monomers have from 3 to 20 carbons, 1 to 4 sites of unsaturation, and from 1 to 5 acid or anhydride groups or salts thereof.

Non-limiting examples of useful ethylenically unsaturated acid-functional monomers include acids such as, for example, acrylic acid, methacrylic acid, α-chloroacrylic acid, α-cyanoacrylic acid, crotonic acid, α-phenylacrylic acid, (3-acryloxypropionic acid, fumaric acid, maleic acid, sorbic acid, α-chlorosorbic acid, angelic acid, cinnamic acid, p-chlorocinnamic acid, beta-stearylacrylic acid, citraconic acid, mesaconic acid, glutaconic acid, aconitic acid, tricarboxyethylene, 2-methyl maleic acid, itaconic acid, 2-methyl itaconic acid, monoesters of maleic anhydride, methyleneglutaric acid, and the like or mixtures thereof. Suitable ethylenically unsaturated acid-functional monomers include acrylic acid, methacrylic acid, crotonic acid, fumaric acid, maleic acid, 2-methyl maleic acid, itaconic acid, 2-methyl itaconic acid and mixtures thereof. Other ethylenically unsaturated acid-functional monomers include acrylic acid, methacrylic acid, crotonic acid, fumaric acid, maleic acid, itaconic acid, and mixtures thereof. Commonly, ethylenically unsaturated acid-functional monomers include acrylic acid, methacrylic acid, maleic acid, crotonic acid, and mixtures thereof. Acrylic acid and methacrylic acid are preferred acid-functional monomers.

Non-limiting examples of suitable ethylenically unsaturated anhydride monomers include compounds derived from the above acids (e.g., as pure anhydride or mixtures of such). Typical anhydrides include acrylic anhydride, methacrylic anhydride, and maleic anhydride.

As previously discussed, the acrylic copolymer preferably includes a functional monomer that can be derived from the reaction product of a multifunctional isocyanate and a nucleophilic (meth)acrylic ester. The multi-functional isocyanate preferably includes at least two reactive functional groups, with at least one of the reactive functional groups being an isocyanate group or a blocked isocyanate group. Preferred multi-functional isocyanates include diisocyanates, triisocyanates, and higher order isocyanates (i.e., compounds having 4 or more isocyanate and/or blocked isocyanate groups), with diisocyanates being preferred in some embodiments. The functional monomer preferably includes at least one blocked isocyanate group, and preferably also includes at least one (meth)acrylic group (e.g., at least one structural unit derived from a nucleophilic (meth)acrylic ester). The isocyanate group may be optionally blocked at any suitable time, including prior to synthesis of the functional monomer (e.g., by blocking of one or more isocyanate groups present in an isocyanate-group-containing reactant used to make the functional monomer), during synthesis of the functional monomer, after synthesis of the functional monomer, or a combination thereof.

Suitable diisocyanates may include isophorone diisocyanate (i.e., 5-isocyanato-1-isocyanatomethyl-1,3,3-trimethylcyclohexane); 5-isocyanato-1-(2-isocyanatoeth-1-yl)-1,3,3-trimethylcyclohexane; 5-isocyanato-1-(3-isocyanatoprop-1-yl)-1,3,3-trimethylcyclohexane; 5-isocyanato-(4-isocyanatobut-1-yl)-1,3,3-trimethylcyclohexane; 1-isocyanato-2-(3-isocyanatoprop-1-yl)cyclohexane; 1-isocyanato-2-(3-isocyanatoeth-1-yl)cyclohexane; 1-isocyanato-2-(4-isocy-anatobut-1-yl)cyclohexane; 1,2-diisocyanatocyclobutane; 1,3-diisocyanatocyclobutane; 1,2-diisocyanatocyclopentane; 1,3-diisocyanatocyclopentane; 1,2-diisocyanatocyclohexane; 1,3-diisocyanatocyclohexane; 1,4-diisocyanatocyclohexane; dicyclohexylmethane 2,4′-diisocyanate; trimethylene diisocyanate; tetramethylene diisocyanate; pentamethylene diisocyanate; hexamethylene diisocyanate; ethylethylene diisocyanate; trimethylhexane diisocyanate; heptamethylene diisocyanate; 2-heptyl-3,4-bis(9-isocyanatononyl)-1-pentyl-cyclohexane; 1,2-, 1,4-, and 1,3-bis(isocyanatomethyl)cyclohexane; 1,2-, 1,4-, and 1,3-bis(2-isocyanatoeth-1-yl)cyclohexane; 1,3-bis(3-isocyanatoprop-1-yl)cyclohexane; 1,2-, 1,4- or 1,3-bis(4-isocyanatobuty-1-yl)cyclohexane; liquid bis(4-isocyanatocyclohexyl)-methane; and derivatives or mixtures thereof. In some embodiments, the multifunctional isocyanate can be a trimer compound (e.g., a triisocyanate produced by reacting 1 mole of a triol with 3 moles of a diisocyanate).

In some embodiments, the multifunctional isocyanates can be non-aromatic (e.g., aliphatic). Non-aromatic isocyanates can be particularly desirable for coating compositions intended for use on an interior surface of a food or beverage container. Isophorone diisocyanate (IPDI) and hexamethylene diisocyanate (HMDI) are typically utilized non-aromatic isocyanates.

In some embodiments, the ethylenically unsaturated nucleophilic monomer can be a nucleophilic (meth)acrylic acid derivative. The nucleophilic (meth)acrylic ester can have both an acrylate functionality on the acid-derived portion of the ester and a nucleophile on the alcohol-derived portion of the ester. Typically, the nucleophile is an —OH group, an —NH group, or an —SH group. If an amino group is used as the nucleophile on a nucleophilic (meth)acrylic ester, the amine should preferably have a hindered structure in order to avoid the Michael reaction between the double bond of the acrylate and the amino group. Suitable amines of this type are disclosed, for example, in U.S. Pat. No. 2,744,885 (de Benneville et al.). Examples of nucleophilic (meth)acrylic esters suitable for this use include hydroxyl-functional (meth)acrylates such as hydroxyethyl (meth)acrylate, hydroxypropyl (meth)acrylate and their sulfur homologs, or mixtures thereof.

Typically, the functional monomer can be formed by reacting an amount of the ethylenically unsaturated nucleophilic monomer that reacts with one isocyanate group on the multifunctional isocyanate leaving at least one isocyanate group intact that can be optionally blocked by reaction with a blocking agent. The blocking agent may be any suitable blocking agent that results in the prevention of premature polymerization or crosslinking of the isocyanate group(s) in the prepolymer (curable composition). For example, when a functional monomer is made from the reaction of a nucleophilic (meth)acrylate with a diisocyanate such as isophorone diisocyanate, one equivalent of nucleophile may be reacted with the diisocyanate so that the nucleophilic (meth)acrylate attaches to a portion of the isocyanate groups of isophorone diisocyanate leaving some isocyanate groups intact for blocking with a blocking agent such as those that are discussed below.

Additional suitable blocking agents include, but are not limited to, linear and branched alcohols; phenols and derivatives thereof, such as xylenol; oximes, such as methyl ethyl ketoxime; lactams, such as ε-caprolactam; lactones, such as caprolactone; β-dicarbonyl compounds; hydroxamic acid esters; bisulfate addition compounds; hydroxylamines; esters of p-hydroxybenzoic acid; N-hydroxyphthalimide; N-hydroxysuccinimide; triazoles; substituted imidazolines; tetrahydropyrimidines; caprolactones; and mixtures thereof.

The blocked isocyanate compound can be stable at room temperature as a carbamic acid derivative free of isocyanate radicals capable of being liberated at room temperature. When heated, or reacted with a “deblocking” agent, the isocyanate radicals can be activated, i.e., deblocked and dissociated. For example, in one embodiment, the isocyanate group(s) can be blocked with ε-caprolactone. The ε-caprolactone can volatilize at a temperature of approximately 150° C. exposing the polyisocyanate groups for crosslinking. In other embodiments, one or more equivalents of nucleophile (such as a hydroxyl or an amino group) may be reacted with the multifunctional isocyanate so as to leave at least one isocyanate group intact for blocking. In such embodiments, the multifunctional isocyanate preferably includes at least one isocyanate group or other reactive functional group capable of reacting with a complementary reactive functional group present on the functional monomer to form at least one covalent attachment between the functional monomer and the multifunctional isocyanate.

The blocked isocyanate group can be deblocked after application of the formulated coating composition to the metal substrate (e.g., during curing of the coating composition). In other words, the blocked isocyanate group is preferably deblockable after the coating composition is applied to a substrate. An example of a deblockable isocyanate group is a blocked isocyanate group where the blocking group, when exposed to suitable film-curing conditions, can either (i) disassociate to liberate a free (i.e., unblocked) isocyanate group or (ii) be readily displaced or replaced by another group or component. Deblockable isocyanate groups are capable of deblocking under film-curing conditions so that a covalent linkage can be formed during cure via reaction of the deblocked isocyanate group with another group (e.g., an isocyanate-reactive group such as a hydroxyl, amino, or thiol group). The other group may be present on the acrylic copolymer, an optional crosslinker, or another optional compound. At least a substantial portion, and more preferably a majority, of the deblockable isocyanate groups can be capable of deblocking during exposure to suitable film-curing conditions. For example, a substantial portion (more preferably at least a majority) of the deblockable isocyanate groups can unblock when a metal substrate coated with a coating composition containing the binder is either (a) heated in a 150° C. oven for about 20 minutes or (b) heated in a 230° C. oven for about 12 seconds, 10 seconds or even about 5 seconds. Useful deblockable isocyanate groups can be not readily unblocked during prolonged storage at room temperature, at a temperature of less than about 50° C., or even at temperature of less than about 100° C.

Non-limiting examples of suitable blocking agents include malonates, such as ethyl malonate and diisopropyl malonate; acetylacetone; ethyl acetoacetate; 1-phenyl-3-methyl-5-pyrazolone; pyrazole; 3-methylpyrazole; 3,5 dimethyl pyrazole; hydroxylamine; thiophenol; caprolactam; pyrocatechol; propyl mercaptan; N-methyl aniline; amines such as diphenyl amine and diisopropyl amine; phenol; 2,4-diisobutylphenol; methyl ethyl ketoxime; α-pyrrolidone; alcohols such as methanol, ethanol, butanol and t-butyl alcohol; ethylene imine; propylene imine; benzotriazoles such as benzotriazole, 5-methylbenzotriazole, 6-ethylbenzotriazole, 5-chlorobenzotriazole, and 5-nitrobenzotriazole; methyl ethyl ketoxime (MEKO); diisopropylamine (DIPA); and combinations thereof. Suitable blocking agents for forming deblockable isocyanate groups also include ε-caprolactam, diisopropylamine (DIPA), methyl ethyl ketoxime (MEKO), and mixtures thereof. Additional discussion of suitable blocking techniques and suitable blocked polyisocyanate compounds can be found, for example, in U.S. Pat. No. 8,574,672 (Doreau et al.).

The coating can be formed from a coating composition that comprises a random copolymer having the following structural elements, each structural element bonded to another structural element in a random manner:

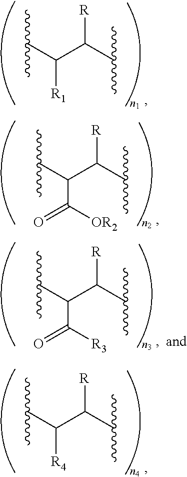

wherein each R is independently H or an alkyl group having one to four carbon atoms, wherein n₁ to n₄ are the number of structural elements of each type in the random copolymer and n₁ is an integer that is zero or greater and n_{z}, n₃, and n₄ are, independently, integers of 1 or greater, wherein each R is independently H or an alkyl group having one to four carbon atoms. In some preferred embodiments, n₁ is less than about 500 and n₂, n₃, and n₄ are, independently less than about 50. R₁ is H or is a group derived from the copolymerization of one or more vinyl monomers (e.g., an alkyl group, more typically a methyl group), R₂ is an alkyl group typically having two to eight carbon atoms, R₃ is H or a salt-forming group, and R₄ is a group having the structure:

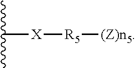

X is an organic group that includes at least one heteroatom-containing linkage in a chain connecting R₅ to a backbone of the random copolymer. More typically, X includes at least two heteroatom-containing linkages. R₅ is an organic group, more typically an alkyl or cycloalkyl group that can, optionally, include one or more heteroatoms (e.g., O, N, P, S, etc.). n₅ can have integral values of 1 to 4, more typically 1, or 2 and even more typically 1. Z is, independently, an isocyanate or blocked isocyanate group. More typically Z is an isocyanate group. In preferred embodiments, X has the following structure:

—(Y)n₆-R₆—W—

wherein n₆ is 0 or 1, more typically 1; Y, if present (i.e., if n₆ is 1), is a heteroatom-containing linkage, and more typically an ester linkage; R₆ is an organic group, more typically an alkyl or cycloalkyl group that can, optionally, include one or more heteroatoms (e.g., O, N, P, S, etc.); and W is a heteroatom-containing linkage, more typically a heteroatom-containing linkage formed by reacting an isocyanate group with an isocyanate-reactive group (e.g. hydroxyl, amino, or thio group), even more typically a urethane linkage.

R and R₁ to R₃ have been defined above. R₄ to R₆ are as indicated. Salt-forming groups are capable of forming ions in the presence of acids or bases and include carboxylic acid or anhydride groups, —OSO₃H groups, groups —OPO₃H groups, —SO₂OH groups, —POOH groups, —PO₃H groups, and combinations thereof.

In preferred embodiments, provided functional monomers include at least one (meth)acrylic group and at least about blocked isocyanate group per monomer unit. One embodiment of the formation of the functional monomer is found in Reaction Scheme (A) below:

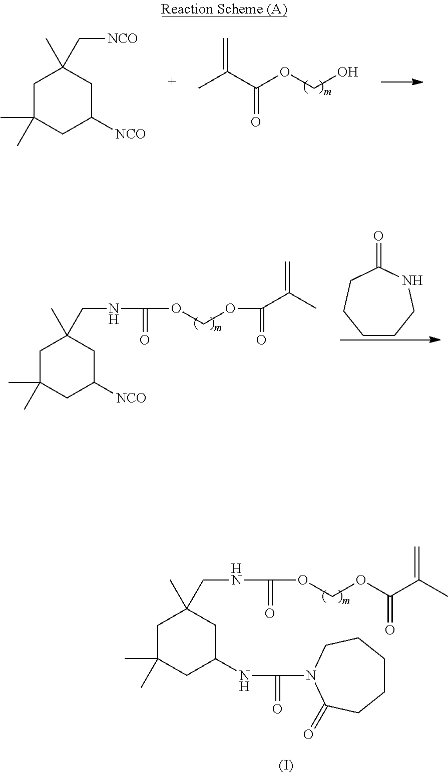

Another embodiment of the formation of the functional monomer is found in Reaction Scheme (B) below:

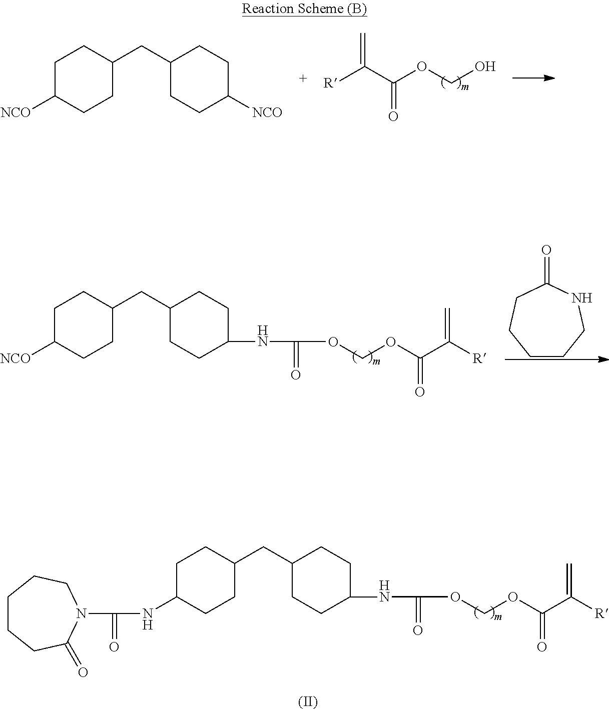

Functional monomer (I) can be formed by the reaction of isophorone diisocyanate with one equivalent of hydroxyethyl methacrylate (or another hydroxyl-functional alkyl meth(acrylate)) the product of which can be reacted with ε-caprolactam to form functional monomer (I) which is useful in provided coating compositions. Functional monomer (II) can be formed by the reaction of hexamethylene diisocyanate with one equivalent of hydroxyethyl methacrylate (or another hydroxyl-functional alkyl meth(acrylate)) the product of which can be reacted with ε-caprolactam to form functional monomer (II) which can be useful in provided coating compositions. The nucleophilic addition can be catalyzed by, for example, dibutyl tin dilaurate.

The aforementioned monomers (an ester of (meth)acrylic acid, (meth)acrylic acid, optionally, a vinyl monomer, and the functional monomer) can be polymerized by standard free radical polymerization techniques, e.g., using initiators such as azoalkanes, peroxides, or peroxy esters to provide an acrylic composition. Typically, the number average molecular weight (“Mₙ”) of the acrylic composition is no greater than 50,000, no greater than 45,000, and even no greater than 40,000. The Mₙ of the acrylic composition is at least 5,000, at least 10,000, or even at least 30,000.

In some embodiments, the monomers can be polymerized in an emulsion. In this process, the polymerization can take place in an aqueous medium using vigorous agitation and a surfactant to help suspend the reagents in small microdomains. The resultant polymer microparticles can be isolated from the reaction mixture usually by filtering. The dispersion of polymer microparticles is known as a latex. With emulsion polymerization much higher molecular weights (much greater than 30,000) can be obtained than with solution polymerization.

Other monomers may be included in the acrylic composition. For example, it may be desirable to include acrylamide, methacrylamide, or an N-alkoxymethyl(meth)acrylamide such as N-isobutoxymethyl (meth)acrylamide, glycidyl (meth)acrylate, hydroxyethyl (meth)acrylate, and the like.

To form the coating composition to be dispersed upon at least a portion of the metal substrate, the acrylic copolymer may be dispersed in a solvent. The solvent may be hydrophobic or hydrophilic. Typical hydrophobic coating composition solvents may include toluene, xylene, mineral spirits, low molecular weight esters such as butyl acrylate, and glycol ethers such as methoxypropyl acetate. In some embodiments, the coating composition can be water-dispersible or water-borne. Prior to being applied to a metal substrate, the coating composition can be formulated by the addition of a crosslinker and other adjuvants as discussed further within.

The acrylic copolymer can be dispersed using salt groups. A salt (which can be a full salt or partial salt) can be formed by neutralizing or partially neutralizing salt-forming groups of the acrylic copolymer (i.e., carboxylic acid groups from the (meth)acrylic acid groups) with a suitable neutralizing agent. The degree of neutralization required to form the desired polymer salt may vary considerably depending upon the amount of salt-forming groups included in the polymer, and the degree of solubility or dispersibility of the salt which is desired. Ordinarily in making the polymer water-dispersible, the salt-forming groups (e.g., acid or base groups) of the polymer can be at least 25% neutralized, at least 30% neutralized, and even at least 35% neutralized, with a neutralizing agent in water. Typically the salt-forming groups are substantially neutralized.

Non-limiting examples of anionic salt groups include neutralized acid or anhydride groups, —OSO₃H groups, —OPO₃H groups, —SO₂OH groups, —PO₂H groups, —PO₃H groups, and combinations thereof. Non-limiting examples of suitable cationic salt groups include quaternary ammonium groups, quaternary phosphonium groups, tertiary sulfate groups and combinations thereof. Non-limiting examples of non-ionic water-dispersing groups include hydrophilic groups such as ethylene oxide groups. Compounds for introducing the aforementioned groups into polymers are known in the art.

Non-limiting examples of neutralizing agents for forming anionic salt groups include inorganic and organic bases such as amines, sodium hydroxide, potassium hydroxide, lithium hydroxide, ammonia, and mixtures thereof. Nitrogen-containing fugitive bases, which expelled or removed during cure of the coating compositions, are preferred neutralizing agents in some embodiments. In certain embodiments, tertiary amines can be the neutralizing agents. Non-limiting examples of suitable tertiary amines include trimethyl amine, dimethylethanol amine (also known as dimethylamino ethanol), methyldiethanol amine, triethanol amine, ethyl methyl ethanol amine, dimethyl ethyl amine, dimethyl propyl amine, dimethyl 3-hydroxy-1-propyl amine, dimethylbenzyl amine, dimethyl 2-hydroxy-1-propyl amine, diethyl methyl amine, dimethyl 1-hydroxy-2-propyl amine, triethyl amine, tributyl amine, N-methyl morpholine, and mixtures thereof. Typically, triethyl amine or dimethyl ethanol amine are used in provided coating formulations.

Alternatively, a surfactant may be used in place of (or in addition to) water-dispersing groups to aid in dispersing the acrylic copolymer in an aqueous carrier. Non-limiting examples of suitable surfactants compatible with food or beverage packaging applications include alkyl sulfates (e.g., sodium lauryl sulfate), dodecylbenzene sulphonic acid (e.g., neutralized with an amine or other fugitive base), ether sulfates, phosphate esters, sulphonates, and their various alkali, ammonium, amine salts and aliphatic alcohol ethoxylates, and mixtures thereof. The surfactant, if present, can also be a polymerizable surfactant.

The amount of the acrylic copolymer present in the coating composition, based on total nonvolatile weight, can be at least 5 wt %, at least 20 wt %, at least 30 wt %, and even at least 35 wt %. The amount of the water-dispersible acrylic copolymer present in the coating composition, based on total nonvolatile weight, can be up to 100 wt %, no greater than 95 wt %, no greater than 85 wt %, no greater than 70 wt %, and even no greater than 60 wt %.

Before the coating composition is disposed on at least a portion of the metal substrate it can be formulated with the addition of other ingredients that can, for example, help to cure the coating composition, help to improve the coatability of the coating composition, help to improve the adhesion of the coating composition to the substrate, help to improve the appearance of the coating composition, help to improve the handling of the coating composition and so forth.

Typically, a curing agent or crosslinker can be admixed with the acrylic copolymer to promote the curing of the composition (typically thermal curing, although other suitable cure mechanisms may also be employed) after it has been applied to a substrate. The level of curing agent (i.e., crosslinker) desired will depend, for example, on the type of curing agent, the time and temperature of the bake, and the molecular weight of the polymer. The crosslinker is typically present in an amount of at least 1 wt %, at least 5 wt %, at least 10 wt %, or even at least 15 wt %. The crosslinker can be present in an amount of at most 50 wt %, at most 40 wt %, and more preferably at most 30 wt %. These weight percentages are based upon nonvolatile weight in the coating composition.

Useful curing agents can be multifunctional oligomers or low molecular weight polymers that include groups that can be reactive with the isocyanate groups (which may be blocked and/or unblocked) on the acrylic copolymer. Typical curing agents include multifunctional amines, amino alcohols, polyesters, polyhydroxyls, polyethylene imine, melamines, amino resins, phenolic resins, and the like. Multifunctional amine curing agents can include, for example, diamines such as, for example, 1,6-hexanediamine; 1,9-octanediamine; 1,10-decanediamine; cyclohexyldiamine; xylylene diamine; polyamidoamine (reaction product of diacid and diamine-terminated polymers); or copolymer vinylics containing an amine group obtained by hydrolysis of vinyl acetate/vinyl ether amine. Water-dispersible multifunctional amines such as poly(propylene amine), partially hydrolyzed chitosan, polyether amines, such as JEFFAMINE polyetheramines (available from Huntsman Corporation, The Woodlands, Tex.) can be utilized. Additionally, melamine crosslinker resins such as the CYMEL 303 product (available from Allnex, Brussels, Belgium) can react with isocyanates such as those in the acrylic copolymer resulting from the incorporation of the functional monomer. However, melamine crosslinkers may contain residual amounts of formaldehyde which may not be desirable in food container coatings. Thus, in some embodiments, it may be desirable to only use crosslinkers that are free of structural units derived from formaldehyde. Typically, polyether amines that are formaldehyde-free are used in these applications. Additionally, water-soluble polyesters may be useful such as polyethers based on dimethylolpropionic acid, trimellitic anhydride, or polydimethylacrylamide (PMDA) and their homologs.

The provided coatings may also include other optional polymers that do not adversely affect the coating composition or a cured coating composition resulting therefrom. Such optional polymers are typically included in a coating composition as a filler material, although they can be included as a crosslinking material, or to provide desirable properties. Typically, optional polymers are substantially free of mobile, and in some embodiments bound, BPA (bisphenol A) and aromatic glycidyl ether compounds (e.g., bisphenol A diglycidyl ether, bisphenol F diglycidyl ether, and epoxy novolacs). Such additional polymeric materials can be nonreactive, and hence, simply function as fillers. Alternatively, such additional polymeric materials or monomers can be reactive with the acrylic copolymer. If selected properly, such polymers and/or monomers can be involved in crosslinking.

One or more optional polymers or monomers (such as those used for forming such optional polymers), can be added to the composition after the acrylic copolymer is dispersed in a carrier. Alternatively, one or more optional polymers or monomers (such as those used for forming such polymers), can be added to a reaction mixture at various stages of the reaction (i.e., before the acrylic copolymer is dispersed in a carrier). For example, a nonreactive filler polymer can be added after dispersing the acrylic copolymer in the carrier. Alternatively, a nonreactive filler polymer can be added before dispersing the acrylic copolymer in the carrier. Such optional nonreactive filler polymers can include, for example, polyesters, acrylics, polyamides, polyethers, novolacs, polyvinyl chlorides (PVC), and polyolefins. If desired, reactive polymers can be incorporated into the compositions of the present invention, to provide additional functionality for various purposes, including crosslinking. Examples of such reactive polymers include, for example, functionalized polyesters, acrylics, polyamides, and polyethers. The one or more optional polymers (e.g., filler polymers) can be included in a sufficient amount to serve an intended purpose, but not in such an amount to adversely affect a coating composition or a cured coating composition resulting therefrom.

The provided coating compositions may also include other optional ingredients that do not adversely affect the coating composition or a cured coating composition resulting therefrom. Such optional ingredients can be included in a coating composition to enhance composition esthetics, to facilitate manufacturing, processing, handling, and application of the composition, and to further improve a particular functional property of a coating composition or a cured coating composition resulting therefrom. Optional ingredients can include, for example, catalysts, dyes, pigments, toners, extenders, fillers, lubricants, anticorrosion agents, flow control agents, thixotropic agents, dispersing agents, antioxidants, adhesion promoters, light stabilizers, biocides, fungicides, skid resistant agents, agents that protect against ultraviolet exposure, suppressants, surface tension agents, air release agents, initiators, photoinitiators, slip modifiers, thixotropic agents, forming agents, antifoaming agents, waxes, oils, plasticizers, antistatic agents, gloss modulating agents, opacifiers, pH adjusting agents, visual enhancement aids such as meal flakes, toners, surfactants, and curing promotors such as drying aids. Each optional ingredient can be included in a sufficient amount to serve its intended purpose, but not in such an amount to adversely affect a coating composition or a cured coating composition resulting therefrom.

One optional ingredient can be a catalyst that can increase the rate of cure. If used, a catalyst is typically present in an amount of at least 0.05 wt %, or at least 0.1 wt % based on the total nonvolatile weight of the coating composition. If used, a catalyst is typically present in an amount of at most 1 wt %, or even at most 0.5 wt % based on the total nonvolatile weight of the coating composition. Examples of catalysts, include, but are not limited to, strong acids (e.g., dodecylbenzene sulphonic acid (available as CYCAT 600), methane sulfonic acid, p-toluene sulfonic acid, dinonylnaphthalene disulfonic acid, triflic acid, quaternary ammonium compounds, phosphorous compounds, and tin and zinc compounds, such as tetraalkyl ammonium halides, tetraalkyl or tetraaryl phosphonium iodides or acetates, tin octoate, zinc octoate, triphenylphosphine, bismuth derivatives, and similar catalysts known to persons skilled in the art.

Another useful optional ingredient can be a lubricant, like a wax, that can facilitate manufacture of metal closures by imparting lubricity to sheets of coated metal substrate. A lubricant can be present in the coating composition in an amount of 0 wt % to about 2 wt %, or from about 0.1 wt % to about 2 wt %, based on the total nonvolatile weight of the coating composition. Exemplary lubricants include Carnauba wax and polyethylene type lubricants.

Examples of fillers and extenders include talc, silicon dioxide, titanium dioxide, wallastonite, mica, alumina trihydrate, clay calcium carbonate, magnesium carbonate, barium carbonate, calcium sulfate, magnesium sulfate, and barium sulfate. Another useful optional ingredient is a pigment, like titanium dioxide. A pigment, like can be optionally present in the coating composition in an amount of 0 wt % to about 70 wt %, from 0 wt % to about 50 wt %, or even 0 wt % to about 40 wt %, based on the total nonvolatile weight of the coating composition.

Surface tension agents may be included in the coating to lower surface tension at the surface of the cured or uncured composition and include, silicones such as dimethyl silicones, liquid condensation products of dimethylsilane diol, methyl hydrogen polysiloxanes, liquid condensation products of methyl hydrogen silane diols, dimethyl silicones, aminopropyltriethoxysilane and methyl hydrogen polysiloxanes, and fluorocarbon surfactants such as fluorinated potassium alkyl carboxylates, fluorinated alkyl substituted ammonium iodides, ammonium perfluoroalkyl carboxylates, fluorinated alkyl esters, and ammonium perfluoroalkyl sulfonates. Representative commercially available surface tension agents include the BYK-306 silicone surfactant (available from BYK-Chemie USA, Inc.), DC100 and DC200 silicone surfactants (available from Dow Corning Co.), the MODAFLOW series of additives (available from Solutia, Inc.), and SF-69 and SF-99 silicone surfactants (available from GE Silicones Co.). When employed, the surface tension agent amount may be up to about 1 wt %, or from about 0.01 wt % to about 0.5 wt % of the coating composition.

Air release agents may assist in curing the coating composition without entrapping air and thereby causing weakness or porosity in the cured coating composition. Typical air release agents include silicon and non-silicon materials such as silicon defoamers, acrylic polymers, hydrophobic solids, and mineral oil-based paraffin waxes. Representative commercially available air release agents include BYK-066, BYK-077, BYK-500, BYK-501, BYK-515, and BYK-555 defoamers (available from BYK-Chemie USA, Inc.). When used, the air release agents may be present in up to about 1.5 wt %, up to about 1 wt %, or even from about 0.1 wt % to about 0.5 wt % of the coating composition.

Coating compositions of the present disclosure may be prepared by conventional methods in various ways. For example, the coating compositions may be prepared by simply admixing the acrylic copolymer, optional crosslinker and any other optional ingredients, in any desired order, with sufficient agitation. The resulting mixture may be admixed until all the composition ingredients are substantially homogeneously blended. Alternatively, the coating compositions may be prepared as a liquid solution or dispersion by admixing an optional carrier liquid, functional acrylic copolymer, optional crosslinker, and any other optional ingredients, in any desired order, with sufficient agitation. An additional amount of carrier liquid may be added to the coating compositions to adjust the amount of nonvolatile material in the coating composition to a desired level.

The provided coating compositions can be used to form protective films on a wide range of metal-containing substrate. The coating compositions can be well suited as coatings on food and beverage packaging articles. The coating compositions can be coated onto all or a portion of such packages or components thereof. The coating compositions can be applied onto the packaging articles after the articles are formed, onto components of the articles prior to assembly, or onto stock that is subsequently fabricated into the packaging articles or components thereof. The coating compositions may be formed on surfaces that are or will be on the interior or exterior of the packaging article.

The provided coating compositions can be applied directly or indirectly onto all or a portion of the metal substrate. In some modes of practice, optionally, one or more other types of coating compositions or packaging features may be interposed between the coating compositions and the substrate. For example, printed or other visually observable features may be formed on the substrate and then the coating composition can be applied onto the features. The coating composition may be applied after the features are cured. Coating compositions applied over printed features are referred to in the industry as overprint varnishes. The provided coating compositions provide durable, abrasion-resistant, water-resistant, and tough overprint varnishes. Waterborne embodiments can have very low VOC (volatile organic component) and can be environmentally friendly.

Optionally, one or more other kinds of coating may be applied over resultant coatings to achieve a variety of performance objectives. For example, stain-resistant coatings, oxygen or other barriers, additional printing or labels, ultraviolet protection layers, security indicia, authentication indicia, and/or combinations of these may be used, if desired.

The coating formulations can be formulated to resist drying prematurely and yet can be easily coated onto substrates and cured to form high quality protective films. Consequently, the coating composition can be applied to substrates using a wide variety of techniques. Exemplary coating techniques include roller coating, spraying, brushing, spin coating, curtain coating, immersion coating, powder coating, and the like.

After coating onto the metal substrate, the coating composition can be allowed or caused to cure to form a protective film. Heating coated substrates can facilitate rapid curing. Provided coating compositions can be cured by passing the substrate through a thermal or electron beam curing. It is contemplated that, since the curing reaction may be subject to acid catalysis, it might be possible to use actinic radiation to cure the compositions if a cationic photoinitiator is present in the formulation. A catalyst may or may not be present in the composition. Useful catalysts are discussed elsewhere herein. The residence time of the coated metal substrate within the confines of the curing oven can be from one to twenty minutes when the curing temperature is in the range of 150° C. to 220° C. In some embodiments, higher oven temperature can be used to cure the coatings more rapidly. For example, for some coatings, curing can be achieved with a residence time of about 5 seconds to about 15 seconds when the curing oven is from about 240° C. to about 260° C. In other words, curing the coating composition can include heating the coating composition to a temperature of from about 150° C. to about 260° C. for from about 20 minutes to about 5 seconds.

It is contemplated that some embodiments of the provided coating compositions will have utility in the following exemplary coating end uses.

A coil coating is described as the coating of a continuous coil composed of a metal (e.g., steel or aluminum). Once coated, the coating coil is subjected to a short thermal, and/or ultraviolet and/or electromagnetic curing cycle, which lead to the drying and curing of the coating. Coil coatings provide coated metal (e.g., steel and/or aluminum) substrates that can be fabricated into formed articles such as 2-piece drawn food containers, 3-piece food containers, food container ends, drawn and ironed containers, beverage container ends and the like. In some embodiments, the provided coil coatings may be used for non-packaging end uses, such as, for example, industrial coil coatings, coil coatings for metal building materials, etc.

A sheet coating is described as the coating of separate pieces of a variety of materials (e.g., steel or aluminum) that have been pre-cut into square or rectangular ‘sheets’. Typical dimensions of these sheets are approximately one square meters. Once coated, each sheet is cured. Once dried and cured, the sheets of the coated substrate can be collected and prepared for subsequent fabrication. Sheet coatings provide coated metal (e.g., steel or aluminum) substrates that can be successfully fabricated into formed articles such as 2-piece drawn food containers, 3-piece food containers, food container ends, drawn and ironed containers, beverage container ends and the like.

A side seam coating is described as the spray application of a liquid coating over the welded area of formed three-piece food containers. When three-piece food containers are being prepared, a rectangular piece of coated substrate is formed into a cylinder. The formation of the cylinder is rendered permanent due to the welding of each side of the rectangle via thermal welding. Once welded, each can typically requires a layer of liquid coating, which protects the exposed ‘weld’ from subsequent corrosion or other effects to the contained foodstuff. The liquid coatings that function in this role are termed ‘side seam stripes’. Typical side seam stripes are spray applied and cured quickly via residual heat from the welding operation in addition to a small thermal and/or ultraviolet and/or electromagnetic oven. The provided compositions can be used to coil coat, sheet coat, or side seam coat food containers.

In some modes of practice, the provided coating compositions are suitable for forming overprint varnish coatings on food and/or beverage packaging, particularly as overprint varnish coatings over printed information applied directly or indirectly onto metal components of such packaging. The printed information can be applied using any suitable technique including but not limited to applying onto a packaging component, applying onto a substrate that is later converted into all or a portion of packaging, applied onto a substrate such as paper or the like that is then applied onto all or a portion of the packaging, or the like. The coating composition then may be applied onto all (e.g., flood coating) or a portion (e.g., spot coating) of the information and cured to form a protective coating. The coating may be clear or tinted and may produce a dull, satin, or glossy finish. More than one type of overprint varnish may be used to create special effects.

A wide variety of print layers can be coated with the overprint varnish. Exemplary embodiments of a print layer generally include a binder component including at least one resin (oligomer or polymer), at least one colorant, and a liquid carrier. The binder component may include one or more thermoplastic and/or thermosetting resins. The liquid carrier may be aqueous or organic and may include a combination of water and organic constituents. Typical liquid carriers are organic in which water is excluded or limited to 50 wt % or less, 25 wt % or less, or even 1 wt % or less of the liquid carrier based upon the total weight of the liquid carrier.

Provided coating compositions that contain thermosetting resins may include one or more types of curing functionality. In some embodiments, curing functionality may be provided by the use of aminoplast or multifunctional amino crosslinking agents. In one embodiment, the acrylic copolymer having blocked isocyanate groups can be cured with one or more aminoplast and/or multifunctional amine crosslinking agents. The blocked isocyanate groups can be unblocked thermally and can be catalyzed by catalysts such as, for example, dibutyl tin dilaurate.

In certain preferred embodiments, the coating composition can be a water-based coating composition that includes at least a film-forming amount of a provided water-dispersible acrylic copolymer. The coating composition can include at least 30 wt % of liquid carrier and more typically at least 50 wt % of liquid carrier. In such embodiments, the coating composition can typically include less than 90 wt % of liquid carrier, more typically less 80 wt % of liquid carrier. For water-borne embodiments, the liquid carrier can be typically at least about 50 wt % water, at least about 60 wt % water, or even at least of about 75 wt % water. In some embodiments, the liquid carrier can be free or substantially free of organic solvent.

In some embodiments, the coating composition is an organic solvent-based composition preferably having at least 20 wt % non-volatile components (“solids”), and more preferably at least 25 wt % non-volatile components. Such organic solvent-based compositions preferably have no greater than 40 wt % non-volatile components, and more preferably no greater than 25 wt % non-volatile components. In some embodiments, the coating composition is a solvent-based system that includes no more than a de minimus amount of water (e.g., less than 2 wt % of water), if any.

In certain embodiments, the provided coating compositions are storage stable (e.g., do not separate into layers and maintain their mechanical performances and chemical resistance) under normal storage conditions for at least 1 week, more at least 1 month, or even at least 3 months. In some embodiments, the cured coating composition of the present disclosure preferably has a glass transition temperature (“T_{g}”) of at least 20° C., at least 30° C., at least 50° C., at least 60° C. or even more. In some embodiments, the T_{g} of the cured coating composition can be less than about 80° C., less than about 70° C., or even less than about 60° C. An example of a useful methodology for determining the Tg of a cure coating is the differential scanning calorimetry test method described in U. S. Pat. App. Pub. No. 2003/0206756 (Kanamori et al.).

In some embodiments, the coating composition of the present disclosure (e.g., packaging coating embodiments) prior to cure on the substrate (e.g., the liquid coating composition), can include less than 1,000 parts-per-million (“ppm”), less than 200 ppm, or even less than 100 ppm of low-molecular weight (e.g., <500 g/mol, <200 g/mol, <100 g/mol, etc.) ethylenically unsaturated compounds. The provided coating compositions can be substantially free of mobile bisphenol A (“BPA”) and the diglycidyl ether of BPA (known as “BADGE”), or even essentially free or even completely free of these compounds. The provided coating compositions are also substantially free of bound BPA and BADGE, essentially free of these compounds, and even completely free of these compounds. In addition, the provided compositions can be also substantially free, essentially free, or even completely free of: bisphenol S, bisphenol F, and the diglycidyl ether of bisphenol F or bisphenol S.

In some embodiments, the acrylic copolymer of the present disclosure (and preferably the coating composition) is at least substantially “epoxy-free,” more preferably “epoxy-free.” The term “epoxy-free,” when used herein in the context of a polymer, refers to a polymer that does not include any “epoxy backbone segments” (i.e., segments formed from reaction of an epoxy group and a group reactive with an epoxy group). Thus, for example, a polymer having backbone segments that are the reaction product of a bisphenol (e.g., bisphenol A, bisphenol F, bisphenol S, etc.) and a halohdyrin (e.g., epichlorohydrin) would not be considered epoxy-free. However, a vinyl polymer formed from vinyl monomers and/or oligomers that include an epoxy moiety (e.g., glycidyl methacrylate) would be considered epoxy-free because the vinyl polymer would be free of epoxy backbone segments.

In some embodiments, the provided coating compositions can be “PVC-free.” That is, the coating composition can contains less than 2 wt %, less than 0.5 wt %, or even less than 1 ppm of vinyl chloride materials or other halogen-containing vinyl materials. When the provided coating compositions utilize non-melamine or non-phenolic crosslinkers they may be substantially free of formaldehyde, essentially free of formaldehyde, or even completely free of formaldehyde.

The disclosed coating composition can be present as a layer of a mono-layer coating system or one or more layers of a multi-layer coating system. The coating composition can be used as a primer coat, an intermediate coat, a top coat, or a combination thereof. The coating thickness of a particular layer and the overall coating system will vary depending upon the coating material used, the substrate, the coating application method, and the end use for the coated article. Mono-layer or multi-layer coating systems including one or more layers formed from a coating composition of the present invention may have any suitable overall coating thickness, but for packaging coating end uses will typically have an overall average dry coating thickness of from about 1 micron to about 60 microns and more typically from about 2 microns to about 15 microns. Typically, the average total coating thickness for rigid metal food or beverage container applications will be about 3 microns to about 10 microns. Coating systems for closure applications may have an average total coating thickness up to about 15 microns. In certain embodiments in which the coating composition is used as an interior coating on a drum (e.g., a drum for use with food or beverage products), the total coating thickness may be approximately 25 microns.

Cured coatings of the provided coating compositions can adhere well to metal (e.g., steel, tin-free steel (TFS), tin plate, electrolytic tin plate (ETP), aluminum, etc.) and can provide high levels of resistance to corrosion or degradation that may be caused by prolonged exposure to products such as food or beverage products. The coatings may be applied to any suitable surface, including inside surfaces of containers, outside surfaces of containers, container ends, and combinations thereof. As previously discussed, the coating may also have utility in non-packaging coating end uses such as, for example, industrial coatings, marine coatings, architectural coatings, toys, automotive coatings, metal furniture coatings, coil coatings for household appliances, floor coatings, and the like. It is also contemplated that the coatings may also be useful use in coating substrates other than metallic substrates.

The coating composition can be applied on a substrate (e.g., a metal substrate) prior to, or after, forming the substrate into an article. In some embodiments, at least a portion of a planar substrate (typically a planar metal substrate) is coated with one or more layers of the coating composition of the present disclosure, which is then cured before the substrate is formed into an article (e.g., via stamping, drawing, draw-redraw, etc.). After applying the coating composition onto a substrate, the composition can be cured using a variety of processes, including, for example, oven baking by either conventional or convection methods. The curing process may be performed in either discrete or combined steps. For example, the coated substrate can be dried at ambient temperature to leave the coating composition in a largely un-crosslinked state. The coated substrate can then be heated to fully cure the coating composition. In certain instances, the coating composition can be dried and cured in one step. In some embodiments, the provided coating composition can be a heat-curable thermoset coating composition. The provided coating composition may be applied, for example, as a mono-coat direct to metal (or direct to pretreated metal), as a primer coat, as an intermediate coat, as a topcoat, or any combination thereof.

Embodiments of the provided coating compositions formulated using the acrylic copolymer can be particularly useful as adherent coatings on interior or exterior surfaces of metal packaging containers. Non-limiting examples of such articles include closures (including, e.g., internal surfaces of twist-off caps for food and beverage containers); internal crowns; two and three-piece metal containers (including, e.g., food and beverage containers); shallow drawn containers; deep drawn containers (including, e.g., multi-stage draw and redraw food containers); can ends (including, e.g., riveted beverage container ends and easy open can ends); monobloc aerosol containers; and general industrial containers, containers, and can ends; and drug containers such as metered-dose-inhaled (“MDI”) containers.

The aforementioned coating compositions formulated using a water-dispersible acrylic copolymer can be particularly well adapted for use as a coating for two-piece containers, including two-piece containers having a riveted can end for attached a pull tab thereto. Two-piece containers are manufactured by joining a can body (typically a drawn metal body) with a can end (typically a drawn metal end). In preferred embodiments, the coating compositions are suitable for use in food-contact situations and may be used on the inside of such containers. The coatings are also suited for use on the exterior of the containers. Notably, the coatings are well adapted for use in a coil coating operation. In this operation, a coil of a suitable substrate (e.g., aluminum or steel sheet metal) is first coated with the coating composition (on one or both sides), cured (e.g., using a bake process), and then the cured substrate is formed (e.g., by stamping or drawing) into the can end or can body or both. The can end and can body are then sealed together with a food or beverage contained therein.

Some embodiments of provided coating compositions can be particularly well adapted for use as an internal or external coating on a riveted beverage container end (e.g., a beer or soda can end). These coatings can exhibit an excellent balance of corrosion resistance and fabrication properties (including on the harsh contours of the interior surface of the rivet to which the pull tab attaches) when applied to metal coil that is subsequently fabricated into a riveted beverage container end.

A method is also provided that includes providing a coating composition that includes an acrylic copolymer having one or more pendant isocyanate groups attached to the acrylic copolymer and applying the coating composition to at least a portion of the metal substrate. In some embodiments, the acrylic copolymer can include the reaction product of an ethylenically unsaturated monomer and a functional monomer. The functional monomer can be derived from the reaction product of a multifunctional isocyanate and an ethylenically unsaturated nucleophilic monomer. The functional monomer preferably includes a blocked isocyanate group.

In some embodiments, an aqueous coating composition is provided that includes at least 20 wt % of a water-dispersible acrylic copolymer described herein and at least 20 wt % of a crosslinker, which is preferably a water-dispersible multifunctional amine such as the polyether amines sold under the tradename JEFFAMINE. The weight percent of the acrylic copolymer and the crosslinker are each, independently, based upon the total nonvolatile weight (percent solids) of the coating composition.

Objects and advantages of this invention are further illustrated by the following examples, but the particular materials and amounts thereof recited in these examples, as well as other conditions and details, should not be construed to unduly limit this invention.

### EXAMPLES

### Preparation of Functional Monomer (I)

In a round bottom flask protected from light, equipped with a stirrer, temperature controller, total condenser, and a feeding line, 640 grams (“g”) isophorone diisocyanate (2.88 moles) was heated with stirring. When the temperature reached 65° C., 4.15 g phenothiazine and 0.42 g dibutyltin dilaurate were added. Subsequently, 415.1 g hydroxypropyl methacrylate (3.19 moles) were added over a 3.5 hour period maintaining the temperature between 60° C. to 65° C. by controlling the feed rate. After addition of the methacrylate was completed, the temperature of the reactants was maintained between 60° C. and 65° C. until the isocyanate value was stable and reached the theoretical value based upon 100% reaction with one isocyanate group (theoretical 11.4%; measured 11.2%). At this time 325.8 g ε-caprolactam (2.58 moles) was added over a two hour period (equal fractions added every 15 minutes in order to control and maintain the temperature). When the addition of the ε-caprolactam was completed the temperature of the reaction mixture was raised to 100° C. and maintained at that temperature until the isocyanate value was less than 0.1%. At that point, 346.3 g butylglycol (2-butoxyethanol) were added. The viscosity of the final product was 44.6 Pascal at 25° C. (80% solids).

### Examples 1-3—Preparation of Acrylic Resins 1-3

Acrylic resins for coating packaging containers were prepared as follows. The formulations shown in Table 1 were used for each example.

TABLE I
(Charges for Examples 1-3 (Acrylic Resins 1-3))

| | | Acrylic Resin 1 | Acrylic Resin 2 | Acrylic Resin 3 | Acrylic Resin 4 |
|---|---|---|---|---|---|
| Charge | Material | (grams(moles)) | (grams(moles)) | (grams(moles)) | (grams(moles)) |
| 1 | Butyl glycol | 962.5 | 962.5 | 962.5 | 962.5 |
| 2 | Styrene | 254 (2.44) | 254 (2.44) | 329 (3.16) | 254 |
| 2 | Ethyl acrylate | 254 (2.54) | 254 (2.54) | 329 (3.29) | 254 |
| 2 | Acrylic Acid | 192 (2.66) | 192 (2.66) | 192 (2.66) | 8.5 |
| 2 | Functional monomer | 375 (0.64) | 375 (0.64) | 187.5 (0.32) | 375 |
| | (I) (80% solids) | | | | |
| 2 | TRIGONOX 21 (t- | 60 | 30 | 30 | 60 |
| | butyl peroxy-2-ethyl | | | | |
| | hexanoate) | | | | |
| 3 | TRIGONOX 21 (t- | 10 | 10 | 10 | 10 |
| | butyl peroxy-2-ethyl | | | | |
| | hexanoate) | | | | |
| 4 | Dimethyl | 237.5 | 237.5 | 237.5 | 0 |
| | ethanolamine ((2- | | | | |
| | dimethylamino) | | | | |
| | ethanol) | | | | |
| 4 | Water | 119.3 | 113.6 | 0 | 0 |

Charge 1 (butyl glycol) was added to a round bottom flask equipped with a stirrer, condenser, temperature control system, and feeding line under inert gas. The charge was heated to 110° C. with stirring. The materials in charge 2 (styrene, ethyl acrylate, acrylic acid, functional monomer (I) and initiator (TRIGONOX 21, available from Akzo Nobel, Amsterdam, The Netherlands) were admixed and added over a three hour period to the stirred and heated butyl glycol. At the end of the addition, the reaction mixture was stirred an additional one hour at 110° C. An additional spike (charge 3) of initiator was added to the reaction mixture and heating and stirring were continued at 110° C. for two hours. The mixture was cooled to 95° C. and a mixture of dimethyl aminoethanol and water (charge 4) was added over a 40 minute period. The stirred reaction product was allowed to cool to room temperature to yield the appropriate acrylic resin.

TABLE II
Properties of Acrylic Resins 1-3

| Property | Acrylic Resin 1 | Acrylic Resin 2 | Acrylic Resin 3 |
|---|---|---|---|
| Viscosity (Pascals) | 12.1 | 26.6 | 47.0 |
| Solids | 42.1% | 42.4% | 45.5% |
| Acid Value | 116 | 116 | 120 |
| (on dry resin) | | | |

### Example 4—Preparation of Acrylic Resin 4 (Latex)

A pre-emulsion monomer mixture of styrene, 500 parts ethyl acetate, 160 parts acrylic acid, 145 parts hydroxyethyl methacrylate and 242 parts blocked isocyanate methacrylate (e.g., Functional monomer (I)) is prepared under agitation at room temperature. This monomer mixture is added to a solution of 97.6 parts of a surfactant (e.g., amine-neutralized sodium dodecyl benzene sulfonic acid) in 289.5 parts deionized water under vigorous agitation until a stable pre-emulsion is reached. The pre-emulsion was then held under vigorous agitation for 45 more minutes.

17.2 parts of surfactant and 1,850 parts deionized water are added to a glass reactor vessel which is agitated, and heated to 80° C. with a nitrogen sparge. When the reaction mixture reaches 80° C., the pre-emulsion is metered into the reactor vessel over a period of three hours. Fifteen minutes into the pre-emulsion metering, an initiator premix of 2.8 parts ammonium persulfate and 205 parts water is metered into the reactor vessel through a separate line over a period of 210 minutes.

After the metering of the pre-emulsion and initiator premix is completed, each supply line is flushed with deionized water (200 parts total) and the reactor vessel is then held under agitation at 80° C. for an additional two hours. After the polymerization is completed, the reactor vessel is slowly cooled down and filtered to collect the resulting latex emulsion. The resulting latex emulsion is then diluted with a solution of deionized water and organic solvents to reach a viscosity between 15 and 25 seconds (DIN4@20° C.).

### Examples 5-16

Varnish Formulations 5-16 were water-reducible and consequently required a water-soluble crosslinker having a low vapor pressure in order to avoid its distillation in the oven. A crosslinker containing free potential amino groups (previously blended with butyl glycol (50 part/50 part when it has high viscosity) was added under stirring to the acrylic resin. A minimum of 5 min of stirring homogenization was done then, depending on the final coefficient of friction required for the coating. Optionally, waxes were added under stirring. At the end, the viscosity was adjusted with water to get a varnish in the specifications between 30-70 s DIN4@20° C. The final coatings were between 28-40% solids. The preparation was filtered with a 20 μm filter before use.

### Example 5 (Formulation 5)

62.89 g Acrylic Resin 1 was charged to a mixing vessel. A mixture of 1.57 g CYMEL 303 (melamine crosslinker available from Allnex, Brussels, BELGIUM) and 1.57 g butyl glycol was premixed and then added to Acrylic Resin 1. 33.97 g water was then added with stirring. Formulation 5 was filtered through a 20 μm filter prior to coating. The solution was 28% solids.

### Example 6 (Formulation 6)

62.91 g Acrylic Resin 1 was charged to a mixing vessel. A mixture of 1.54 g JEFFAMINE D230 (polyetheramine with Mₙ of 230, available from Huntsman, The Woodlands, Tex.) and 1.57 g butyl glycol was premixed and then added to Acrylic Resin 1. 33.98 g water was then added with stirring. Formulation 6 was filtered through a 20 μm filter prior to coating. The solution was 28% solids.

### Example 7 (Formulation 7)

Formulation 7 was made according to the procedure described in Formulation 6 with exception that 1.54 g JEFFAMINE D2000 (polyetheramine with Mₙ of 2000, available from Huntsman) was used in place of JEFFAMINE D230.

### Example 8 (Formulation 8)

Formulation 8 was made according to the procedure described in Formulation 6 with exception that 1.54 g JEFFAMINE D400 (polyetheramine with Mₙ of 430, available from Huntsman) was used in place of JEFFAMINE D230.

### Example 9 (Formulation 9)

Formulation 9 was made according to the procedure described in Formulation 6 with exception that 1.54 g JEFFAMINE EDR148 (polyetheramine with Mₙ of 148, available from Huntsman) was used in place of JEFFAMINE D230.

### Example 10 (Formulation 10)

Formulation 10 was made according to the procedure described in Formulation 6 with the exception that 1.28 g JEFFAMINE D2000 was used in place of the JEFFAMINE D230.

### Example 11 (Formulation 11)

Formulation 11 was made according to the procedure described in Formulation 6 except that 0.71 g of JEFFAMINE D2000 was used in place of the JEFFAMINE D230.

### Example 12 (Formulation 12)

Formulation 12 was made according to the procedure described in Formulation 6 with the exception that Acrylic Resin 2 was used in place of Acrylic Resin 1 and 0.71 g. JEFFAMINE D2000 was used in place of the JEFFAMINE D230.

### Example 13 (Formulation 13)

Formulation 13 was made according to the procedure described in Formulation 12 with the exception that Acrylic Resin 3 was used in place of Acrylic Resin 2.

### Example 14 (Formulation 14)

87.34 g Acrylic Resin 1 was charged to a mixing vessel. A mixture of 0.87 g JEFFAMINE D2000 (polyetheramine available from Huntsman, The Woodlands, Tex.) and 2.18 g butyl glycol was premixed and then added to Acrylic Resin 1. 1.05 g MICHEM LUBE 160 PF-E (anionic carnauba wax emulsion available from Michelman, Cincinnati, Ohio) was added to the mixture with stirring. Then 0.52 g. LUBAPRINT 502H (wax dispersion, available from Munzing, Heilbronn, GERMANY) was added to the mixture with stirring. 8.04 g water was then added with stirring. Formulation 14 was filtered through a 20 μm filter prior to coating. The solution was 38% solids.

### Example 15 (Formulation 15)

68.56 g Acrylic Resin 1 was charged to a mixing vessel. A mixture of 1.39 g CYMEL 303 (melamine crosslinker available from Allnex, Brussels, BELGIUM) and 1.39 g butyl glycol was premixed and then added to Acrylic Resin 1. Then 1.23 g MICHEM LUBE 160 PE was added with stirring. 27.43 g water was then added with stirring. Formulation 15 was filtered through a 20 μm filter prior to coating. The solution was 30.5% solids.

### Example 16 (Formulation 16)

68.56 g Acrylic Resin 2 was charged to a mixing vessel. A mixture of 1.39 g CYMEL 303 (melamine crosslinker available from Allnex, Brussels, BELGIUM) and 1.39 g butyl glycol was premixed and then added to Acrylic Resin 2. Then 1.23 g MICHEM LUBE 160 PE was added with stirring. 27.43 g water was then added with stirring. Formulation 16 was filtered through a 20 μm filter prior to coating. The solution was 30.5% solids. Each varnish (formulation) was hand coated on chrome-coated aluminum panels using a hand coater to get a 8-12 g/m² coating. Each sample was cured in a ventilated oven for 12 seconds at 254° C.

### MEK Resistance Test

The panels were double rubbed with a cloth soaked with methyl ethyl ketone. The number of rubs before the coating was removed were recorded.

### Water Retort Resistance Test

The water retort resistance of the flat coated panel was evaluated with an immersion of each coated panel in tap water for 60 min at 130° C. conditions. A rating between 0 to 10 of the blush film aspect after the test was given for the vapor phase of the panel and for the immersion phase of the panel (0 is high blush and 10 is no detected blush). This test was a visual inspection.

### Wedge Bend Test

The wedge bend test was used to evaluate the flexibility of the coating as well the extent of cure. The wedge bend test was performed as described in U. S. Pat. App. Publ. No. 2010/0260954 (Stenson et al.)

TABLE III
Physical Properties of Finished Panels

| | | % | | Retort Blush | Wedge |
|---|---|---|---|---|---|
| Formu- | Acrylic | Cross- | MEK | (immersion/ | Bend |
| lation | Resin | linker | Rubs | vapor) | (%) |
| 5 | 1 | 4.5 | 200 | 9/10 | 58 |
| 6 | 1 | 5.5 | 200 | 9/10 | 61 |
| 7 | 1 | 5.5 | 120 | 9/10 | 61 |
| 8 | 1 | 5.5 | 200 | 9/10 | 58 |
| 9 | 1 | 5.5 | 200 | 9/10 | 48 |
| 10 | 1 | 4.5 | 80 | 9/10 | 62 |
| 11 | 1 | 2.5 | 25 | 9/10 | 64 |
| 12 | 2 | 2.5 | 40 | 9/10 | 52 |
| 13 | 2 | 2.5 | 25 | 9/10 | 0 |
| 14 | 3 | 2.5 | 30 | 9/10 | 55 |
| 15 | 1 | 4.5 | 70 | 9/10 | 0 |
| 16 | 2 | 4.5 | 200 | 9/10 | 56 |

### Storage Stability Test

Some storage stability tests were done on Formulation 5. The samples were stored at room temperature or at 40° C. for up to 19 weeks, coated onto panels, cured, and evaluated as above. The results are shown in Table IV.

TABLE IV
Storage Stability Test Results of Formulation 5

| | | | Wedge | |
|---|---|---|---|---|
| Time | Storage | MEK | Bend | |
| (weeks) | Temp | Rubs | (%) | Retort |
| 0 | | 200 | 58 | |
| 19 | RT | 200 | 60 | |
| 19 | 40° C. | 200 | 57 | |
| 19 | RT¹ | 200 | 60 | |
| 19 | 40° C.¹ | 200 | 59 | |

¹A new formulation 4 was made from aged acrylic resin.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited within this document are hereby incorporated by reference in their entirety.

What is claimed is:

1. An article for packaging comprising:
a metal substrate; and
a coating disposed on at least a portion of the metal substrate, the coating formed from a coating composition that includes an acrylic copolymer having a pendant isocyanate group.

2. (canceled)

3. An article for packaging according to claim 1, wherein the acrylic copolymer comprises the reaction product of:
an ethylenically unsaturated monomer; and
a functional monomer, the functional monomer derived from the reaction product of a multifunctional isocyanate and an ethylenically unsaturated nucleophilic monomer, wherein the functional monomer comprises a blocked isocyanate group.

4. An article for packaging according to claim 1, wherein the metal substrate comprises at least a portion of a food or beverage container.

5. (canceled)

6. (canceled)

7. An article for packaging according to claim 3, wherein the ethylenically unsaturated monomer comprises an alkyl ester of (meth)acrylic acid and a (meth)acrylic acid.

8. (canceled)

9. (canceled)

10. (canceled)

11. An article for packaging according to claim 3, wherein the multifunctional isocyanate comprises a diisocyanate.

12. (canceled)

13. An article for packaging according to claim 3, wherein the functional monomer is selected from: 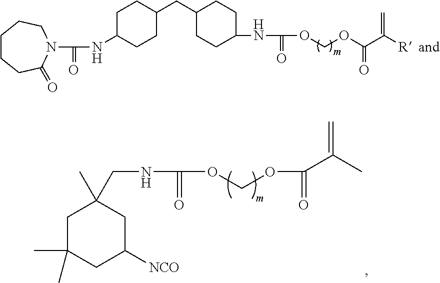
or a combination thereof, wherein m is an integer greater than zero.

14. An article for packaging according to claim 13, wherein m is 2 to 18.

15. An article for packaging according to claim 1, wherein the coating composition further comprises a crosslinker.

16. An article for packaging according to claim 15, wherein the crosslinker comprises a multifunctional amine.

17. An article for packaging according to claim 1, wherein the coating composition is a waterborne system.

18. A method comprising:
providing a coating composition comprising an acrylic copolymer having one or more pendant deblockable blocked isocyanate groups attached to the acrylic copolymer; and
applying the coating composition to at least a portion of a metal substrate.

19. A method according to claim 18, wherein the acrylic copolymer comprises the reaction product of:
an ethylenically unsaturated monomer; and
a functional monomer, the functional monomer derived from the reaction product of a multifunctional isocyanate and an ethylenically unsaturated nucleophilic monomer, wherein the functional monomer comprises a blocked isocyanate group.

20. A method according to claim 18, wherein the acrylic copolymer is water-dispersible.

21. A method according to claim 18, further comprising curing the coating composition to form an adherent hardened coating.

22. A method according to claim 21, wherein curing the coating composition comprises heating the coating composition to a temperature of from about 150° C. to about 260° C. for from about 20 minutes to about 5 seconds.

23. (canceled)

24. (canceled)

25. (canceled)

26. (canceled)

27. A coating composition comprising:
at least 20 weight percent, based upon total nonvolatile weight, of an acrylic copolymer having a blocked isocyanate group; and
a liquid carrier,
wherein the coating composition is substantially free of bisphenol A, bisphenol F, and bisphenol S and is suitable for use in forming a food-contact coating on a food or beverage container.

28. A coating composition according to claim 27, wherein the acrylic copolymer comprises the reaction product of:
an ethylenically unsaturated monomer; and
a functional monomer, the functional monomer derived from the reaction product of a multifunctional isocyanate and an ethylenically unsaturated nucleophilic monomer, wherein the functional monomer comprises a blocked isocyanate group.

29. A coating composition of claim 27, wherein the coating composition comprises an aqueous dispersion of the acrylic copolymer.

30. A coating composition of claim 27, wherein the blocked isocyanate group comprises a reaction product of one or more deblockable blocking agents selected from ε-caprolactam, diisopropylamine, or methyl ethyl ketoxime.

31. (canceled)

32. (canceled)

33. (canceled)
